(19) United States
(12) Patent Application Publication
(10) Pub. No.: US 2002/0049844 A1
(43) Pub. Date: Apr. 25, 2002

(54) Music data distribution mail magazine issuing system

(76) Inventor: Hideki Nishikawa, Tokyo (JP)

Correspondence Address: MASON & ASSOCIATES, PA, 17757 US HWY 19 N., SUITE 500, CLEARWATER, FL, 33764, US

(21) Appl. No.: 09/970,395

(22) Filed: Oct. 3, 2001

(30) Foreign Application Priority Data
Oct. 11, 2000 (JP) 2000-311132
Aug. 7, 2001 (JP) 2001-238940

(51) Int. Cl. G06F 15/16

(52) U.S. Cl. 709/225; 709/229

(57) ABSTRACT

A music data distribution, mail magazine issuing system, that permits users to access, display, listen to and/or download registered data designated by the users, comprises a music data server, for uploading and registering music data held by applicants and for distributing the music data on line upon receiving requests from users; a mail magazine server, for registering correlated character data and image data associated with the applicants, and music data and for distributing on line the character data and the image data together with information provided from the music data distribution, mail magazine issuing system; and a total management server, for managing and controlling the entire system, for determining legal registration appropriateness and for selecting and registering only legally appropriate date. Entertainers or musicians can register their original work data via the Internet, and an unspecified number of users can access and use the registered work data via the Internet.

### BACKGROUND OF THE INVENTION

1. Field of the Invention

The present invention relates to a music data distribution, mail magazine issuing system that permits an unspecified majority of users to engage in the registration, advertising and sale of music data across the Internet.

1. Related Arts

There has recently been a strong surge in e-business start-ups, and in the advance of e-commerce, overall; the so-called IT revolution has had widespread effect and has contributed to the establishment of numerous new trade instrumentalities. Of these, there are a number of Internet systems that have been set up to support commercial dealings in relatively conventional products, and to provide, for a fee, a variety of extended common services, including the online distribution of literary data, such as digital books, for printing or downloading as visible data.

There are also many supporting or proxy business systems for holding inverse auctions, for providing for job seekers a variety of job offers or of job hunting data, for handling the reservation or vending of tickets, or for the performance of clerical tasks. Of the various sites set up to provide data services, many are included that offer entertainment or art associated data; there is even a site whereat entertainment production companies, music and record companies, or movie distributors can register music data or image data that is distributed as digital data in response to user requests. For example, in a manner similar to an on-line karaoke system, music data can be distributed in accordance with the names of songs submitted by users, so that on-line music is available even for users in remote areas.

The creators of the literary and entertainment and art associated data that are offered are generally limited. The data provided by professional writers, songwriters and musical composers are stored in advance, and users, or their sponsors, who access the pertinent data are charged for their use.

This system configuration corresponds to an arrangement whereby recorded data are stored in a jukebox or a karaoke system and are automatically selected in accordance with requests received via a line, such as the Internet.

On the other hand, there are also many cases where youths, students or amateur or semi-professional associations of like-minded persons are not, because of economical reasons and manpower, geographical and time restrictions, afforded the opportunity to present superior literary and entertainment/art associated data, so that their work perforce remains unknown.

This problem is most frequently encountered by amateurs or semi-professional entertainers, and it is predicted that many superior works would be accepted by many people and become popular were appropriated disclosure means available. For example, there is empirical evidence that songs originally released by local stations, including mini FM stations and those employing only wire broadcasting, or in local live houses have became great hits.

In addition, even well-known professional musicians or entertainers desire at time to make available to their many fans works produced based on arrangements differing from those of their agents' offices or the music companies with which they have contracts. In this situation, it is not easy for even such people to disclose their works at their own expense, or through the distribution of CDs or other media.

The reason this situation exists is that commercial objectives often do not correspond to the desires of creators or of those who appreciate the artistic impressions produced by the creators and the quality of their work. From the commercial point of view, priority must be given to works that will quickly be accepted by large numbers of fans and which will meet or exceed sales objectives within a short period of time. However, popular works are not always superior products, and as is described above, there are many examples of their work that entertainers and musicians, regardless of whether they are professionals, semi-professionals or amateurs, will have no opportunity to present to the public.

### SUMMARY OF THE INVENTION

To resolve the above shortcoming, it is one objective of the present invention to provide a music data distribution, mail magazine issuing system that permits many entertainers and musicians, regardless of whether they are professionals, semi-professionals or amateurs, to use the Internet to register data for their work, and that permits an unspecified number of users to employ the Internet, without any geographical or time restrictions, to access these registered data, while further providing a platform for the distribution of new data to addresses submitted by the registerers of data and users.

According to the present invention, a music data distribution, mail magazine issuing system, that permits users to access and to display, listen to and/or download registered data designated by the users, comprises:

a music data server 30, for uploading and registering music data held by registration applicants I, II, III, . . . and for distributing the music data on line upon receiving requests from users 1, 2, 3, . . . ;

a mail magazine server 20, for registering correlated character data and/or image data associated with the registration applicants, and/or music data, and for, as needed, distributing on line the character data and/or the image data together with information provided from the music data distribution, mail magazine issuing system;

a total management server 10, for managing and controlling the entire system, that includes a function for examining the copyrights of data registered at the servers or, when problems arise related to public order and morals and other associated problems, for determining legal registration appropriateness and for selecting and registering only legally appropriate data.

According to the invention, in the music data distribution, mail magazine issuing system, an information distribution form used by the mail magazine server 20 is a mail magazine issued for the registration applicants, and the data is character data, including songs associated with data registered in the music data server 30, registerer profiles, self-advertisements, registerer messages to music data users, and live concert information.

Further, in addition to listening to and downloading data, the music data users, by following predetermined procedures, including the payment of fees, can present as gifts to third parties music data accompanied by digital messages, and the third parties, those who are the gift recipients, can listen to and/or download the music data. Further, the music data users can have distributed, to specific on-line third parties, character data and/or image data associated with the music data.

The music data genres are not specifically limited, and rock'n roll, heavy metal, punk, pops, rock-a-billy, hip-hop, R & B, blues, jazz, classic or fusion data may be provided, while the playing styles or instrument types may be orchestras, wind and string instruments, electric guitars, pianos, violins, guitars or computer music.

Further, the music data may be for only instrumental music, for solos or for instrument and vocal renditions, such as when various instruments are used to accompany choruses, and while these data forms can be published in the mail magazine, they can also be set up for automatic distribution to mail addresses registered for downloading.

The music data reproduction form is not especially limited; however, the music data can be in a form compatible with the Windows (trademark of Microsoft Corp.) Media Player, Real Audio or MIDI.

According to the invention, entertainers (musicians) that desire to use the music data distribution, mail magazine issuing system of the invention, regardless of whether they are professionals or amateurs, individuals or groups, are issued ID codes when they first register with the system, and thereafter the registration and use of music data are collectively managed based on the names of the entertainers and musicians and their ID codes. Therefore, music data registered by the same musician and genre albums in the mail magazine or the list of time-series category albums can be confirmed as needed.

According to the music data distribution, mail magazine issuing system of the invention, the registration of musicians and their subscriptions to the mail magazine are free, while purchasers who download music data are charged a predetermined amount. From these payments, which are remitted digitally or by using a credit card, overhead expenses for system management and server maintenance are subtracted and the money remaining is distributed to the musicians.

In this case, since the number of downloads is incremented and can be confirmed by the mail magazine issuing person, theoretically it will be difficult for problems to occur. Further, advertisements for musical instruments, musical scores and various other music industry related products can be accepted and presented as appropriate, and the advertisement fees can contribute to the improvement of the service and to pay for basic expenses associated with system upkeep and maintenance.

Entertainers who desire to register with the music data distribution, mail magazine issuing system of the invention first access the URL of the system. At this time, when musicians are first registered, registration numbers and IDs are issued to them that are used thereafter for the registration and the use of new works.

Since users tend to be interested in the same type of works by the same entertainers, the user data can be effectively used in a case wherein a mail magazine is to be issued for a new work, or as a list for the transmission of data concerning live concerts.

It is preferable that a template and another input support function be prepared for the registration of musicians and the submission of drafts to the music data distribution, mail magazine issuing system, for data uploading, and for the registration of entries by applicants for the purchase of music distribution mail magazines, and that it be possible for musicians or for users to register by filling in blanks on a displayed input screen in accordance with contents that are first selected and accessed.

Further, multiple standard components, such as headers, footers, cuts and fonts, can be prepared for the screen layout of the mail magazine, and an overall configuration can be determined by selectively combining these components. Naturally, it is preferable that skillful users of these processes be able to form original screen structures.

### BRIEF DESCRIPTION OF THE DRAWINGS

FIG. 1 is a diagram showing the general basic configuration of a music data distribution, mail magazine issuing system according to the present invention;

FIG. 2 is a diagram showing an example display screen for music data that is accumulated by a music data server in the music data distribution, mail magazine issuing system according to the invention;

FIG. 3 is a flowchart showing the processing performed to register a user who desires to receive mail issued by the music data distribution, mail magazine issuing system of the invention;

FIG. 4 is a flowchart showing the processing performed by the music data distribution, mail magazine issuing system of the invention when a registered music data user employs music data;

FIG. 5 is a flowchart showing the processing performed by the music data distribution, mail magazine issuing system of the invention in response to the selection of the use state by a music data user;

FIG. 6 is a diagram showing an example screen for displaying a template used to designate selected music data present in the music data distribution, mail magazine issuing system according to the invention;

FIG. 7 is a flowchart showing the processing performed by a recipient who has accepted a gift from a music data user of the music data distribution, mail magazine issuing system according to the invention; and

FIG. 8 is a diagram showing a birthday card attached to a gift in the music data distribution, mail magazine issuing system according to the present invention.

### DETAILED DESCRIPTION OF THE PREFERRED EMBODIMENT

The present invention relates to a music data distribution, mail magazine issuing system that permits an unspecified majority of users to register, advertise and vend music data across the Internet.

The preferred embodiment of the present invention will now be described while referring to the accompanying drawings. The present invention, however, is not limited to this embodiment.

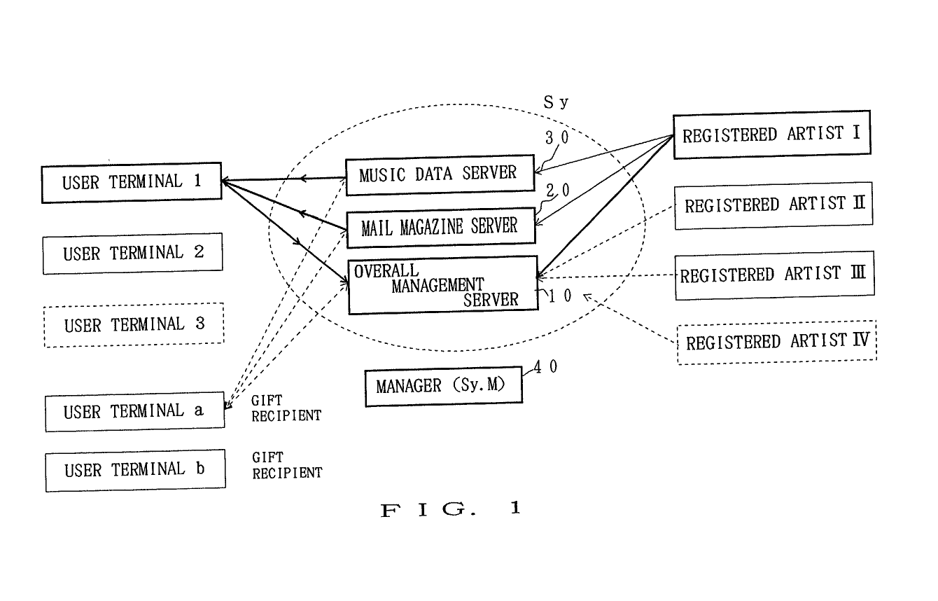

FIG. 1 is a diagram showing the general configuration of a system according to the invention that registers, distributes and vends music data across the internet. A system Sy comprises an overall management server 10, for exercising overall control coordinated by a system manager (Sy.M) 40, a mail magazine server 20 and a music data server 30.

The system can be accessed through the Internet by registerers (artists) I, II, III, . . . who desire to register and who desire that music mail magazines be issued, and by an unspecified majority of users 1, 2, 3, . . . who desire to purchase the registered music mail magazines. The registerer I, who desires to register musical data for distribution and who desires that a music mail magazine be issued, transmits, to the overall management server 10, personal data required for the system registration at the first time and the data, such as musical data, required each time at the registration. It should be noted that the users a, b, . . . are a secondary user group. As will be described later, when a gift of musical data is received from users 1, 2, 3, . . . , who are registered with the system in advance, the users a, b, . . . are permitted to access the system and to listen to and/or download the music data through predetermined procedures.

To register with the system, a desired artist name for registration (the name of a group, the number of members and their names, and the name of the group's agent), a music genre, an account number for money transfers, an e-mail address, a telephone number, and other personal information are transmitted to the system Sy, which then provides a registration number and an ID code for the registerer.

The process thereafter required for the registration of new music data can include the submission of the name of the artist, the registration number, the ID code and the type of music data, such as either instrumental music or with or without a chorus. When, in accordance with the registration procedures, the system Sy determines a submitter is an authorized registerer, the system Sy permits the registerer to enter character data and music data.

The character data submitted for publication in the mail magazine include contents, supplied by registerers for dissemination to users, that will be described later, such as the profiles of the artists, i.e., their nationalities, the companies (groups) with which they are affiliated, their portraits and self-supplied PR releases, the contents of an activity, information concerning their live concerts, URLs for their homepages and additional comments or observations they provide. If songs accompany such character data, when character data are disseminated the song data are included.

To facilitate the entry of character data, the system can provide a template used for entering a music mail magazine registration date, a back number, a standard layout and the name of an artist. The character data that are thus submitted are stored in the mail magazine server 20 for display on user terminal screens when accessed by users, and can be printed if necessary.

Notes for entering music data and, as needed, an example input format are displayed to assist in the entry of music data. And when an entry is received, the music data are temporarily registered with the music data server 30 for later examination by the system manager (Sy.M) 40 to determine whether presenting the data will infringe on a copyright and whether it would constitute a violation of public order and morals, and to decide on the general appropriateness of the music data. If no such problems are discovered, the music data are officially registered, and a music mail magazine including the musical piece is compiled. Then, in response to an access by a user, this music mail magazine is either output to the acoustic device of the user's terminal, or is downloaded.

The users 1, 2, 3, . . . , customers who desire to use the music data distribution, mail magazine issuing system of the invention, can access, via the Internet, the mail magazine server 20 and the music data server 30 managed by the total management server 10 of the system Sy.

When each user is first registered, user information, such the user's name, mailing address, gender, age and payment method, is input by employing an input support tool, such as a template that includes an array matching a predetermined format. When the submission of these entries is completed, a purchase number and ID code are supplied the user. Thus, only the registration number, the ID code or a password need be entered by the user to gain quick access to the system Sy on future occasions.

Of the available conventional music data distribution, mail magazines, a user calls up a magazine that satisfies his or her selection preference, as represented by a specific genre or an artist, and transmits a signal requesting that the data be displayed. Upon receiving this signal, the overall management server 10 selects pertinent data from the mail magazine server 20, and transmits them for display.

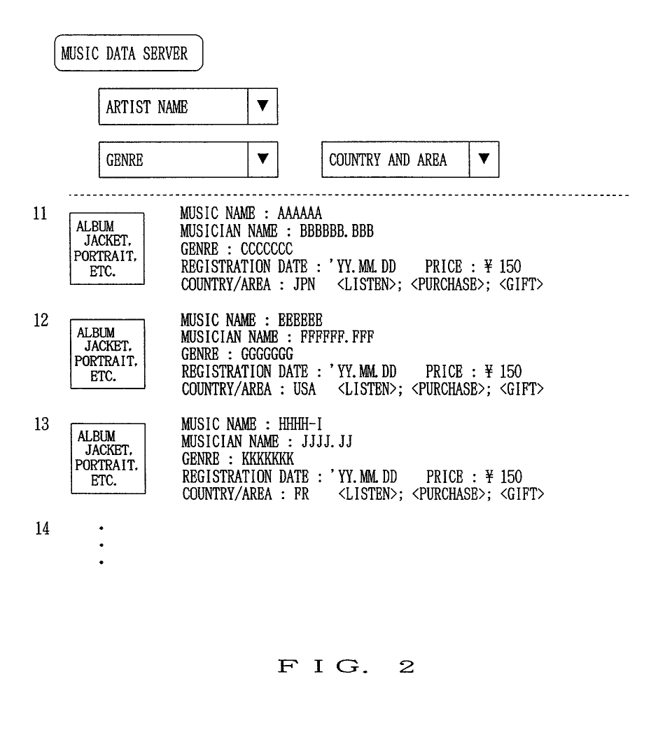

FIG. 2 is a diagram showing an example display for a mail magazine that mainly includes music data. To use the music data, the user clicks on a relevant predetermined item, <listen>, <purchase> or <gift>, and employs the desired form of the data in accordance with the following procedures.

A user thereafter confirms the contents of the display and clicks on a download instruction column, for example, to transmit a signal requesting a desired operation when he or she desires to listen to and/or download the corresponding music data. Then, the user can listen to the music data via the terminal acoustic device, or can download the music data to a removable storage medium, such as a CD-R/RW, a DVD-R/RW or a magneto-optical disk, or to a hard disk.

Further, by employing predetermined procedures and by paying predetermined fees, users can elect to provide music data, together with accompanying material, such as various greeting cards or get-well cards, as gifts for third parties, such as friends, lovers or family groups, regardless of whether the recipients are clients of the system. The gifts can be ones given for the celebration of birthdays, marriages, school matriculations or graduations, debuts as full-fledged members of society, wedding anniversaries, 60th, 70th, 80th or 88th birthdays, or discharges from hospitals; or they may be ones for inquiring after the health of persons, offering consolations for unlucky love affairs, or expressing sympathy. The recipients of the gifts can receive them at their own terminals by entering passwords or ID codes forwarded by mail. By clicking on a downloading instruction column, for example, they can transmit instruction signals for the operations they desire, and can listen to music produced by their own terminal acoustic devices, or can download the music data to removable disks, such as CD-R/RWs, DVD-R/RWs or magneto-optical disks, or to hard disks. It should be noted that the gift recipients will also receive, on line, the character data and/or image data that accompany the music data.

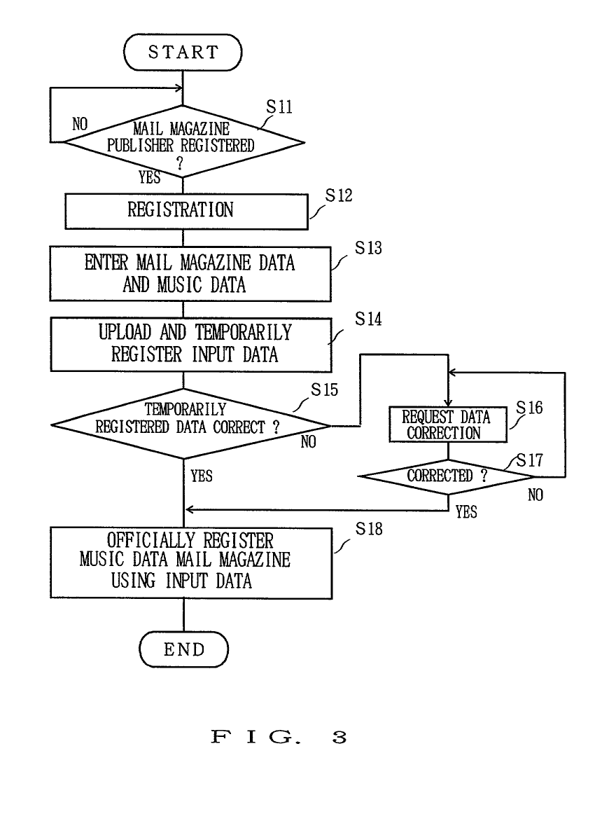

FIG. 3 is a flowchart showing the data input processing, performed by an entertainer or a musician who desires that a music data mail magazine be issued, for entering his or her music data and character data for transmission to purchasers.

When the processing is initiated, a check is performed to determine whether an entertainer or musician who accessed the system Sy is already registered as a mail magazine publisher (step S11). If the entertainer or the musician is not registered, the message “You are not yet registered with this system. Please process your registration from the beginning,” and an input template are displayed for use when requesting registration. Program control thereafter is set to a wait state.

When an official registration is confirmed (step S12), an example message, “Please enter and upload desired character data to be published in a mail magazine and music data that it is desired be attached,” is displayed to request the entry of data, and character data for the mail magazine and music data are entered (step S13). Then, the system Sy temporarily registers the uploaded data (step S14), which it thereafter examines to determine whether the work infringes on the copyright of a third party, whether it imitates other music data, and whether it slanders a third party or is in violation of public order and morals (step S15).

When it is ascertained at step S15 that the temporarily registered data is unauthorized, correction of data is requested with a brief reason (step S16), and program control waits until it is confirmed that data is corrected (step S17). This waiting state is continued until correct data is entered or the system is reset by assuming that no correct data is entered.

When it is ascertained at step S15 that the temporarily registered data is originally authorized, or when it is ascertained that the data obtained by correction is authorized, the character data for the mail magazine and the music data that have been input are officially registered (step S18). As a result, it is determined that a regular music mail magazine will be issued, so that a third party can read and/or purchase (download) the mail magazine.

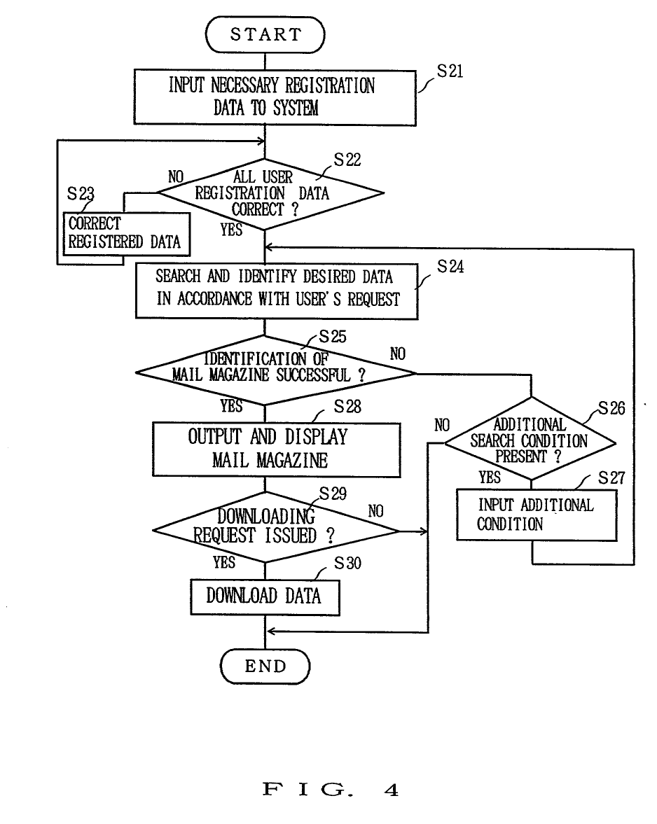

FIG. 4 is a flowchart showing the processing performed by a user who desires to read and/or purchase a music mail magazine, from the time the user is first registered up until a mail magazine is purchased (downloaded).

A message, for example, “Users who have already been registered, please enter necessary data, such as your registration number, your ID code and your password. Users who have not yet been registered, please enter the following data”, is displayed to request users who have accessed the system to make required entries (step S21). Then, a check is performed to determine whether the user registration and identification entries are correct (step S22). When the entered data are not correct, correction of the entries is requested (step S23). Program control thereafter waits until correct entries are made.

When the correct registration for a user is confirmed at step S22, a message, for example, “Please select the mail magazine you desire to read and/or purchase. If you do not know the correct name of the registered music, please enter the name of a musician and the musician's number”, is displayed to request the required entries be made, and a search and an identification check are is performed to determine whether the target mail magazine can be identified (step S25).

When at step S25 the target mail magazine can not be identified, a check is performed to determine whether an additional condition is present (step S26). When the additional condition can be input, the entry of the additional condition is requested (step S27). Then, the search and identification process at step S24 is repeated while taking the additional condition into account. When the additional condition to be input is not present at step S26, a message, “Search disabled”, is displayed, and the processing is thereafter terminated. Whether the search should be halted or should be continued under a new condition depends on a determination made by the user.

When the music mail magazine desired by the user can be identified at step S25, this mail magazine is displayed, and a message to the effect that the listening to and/or downloading of music data are also available is also presented (step S28). Then, a check is performed to determine whether a downloading request has been issued (step S29). When the request has been issued, the music data is downloaded (step S30), and the processing is thereafter terminated. When a downloading request has not been issued, the processing is terminated without performing any further process.

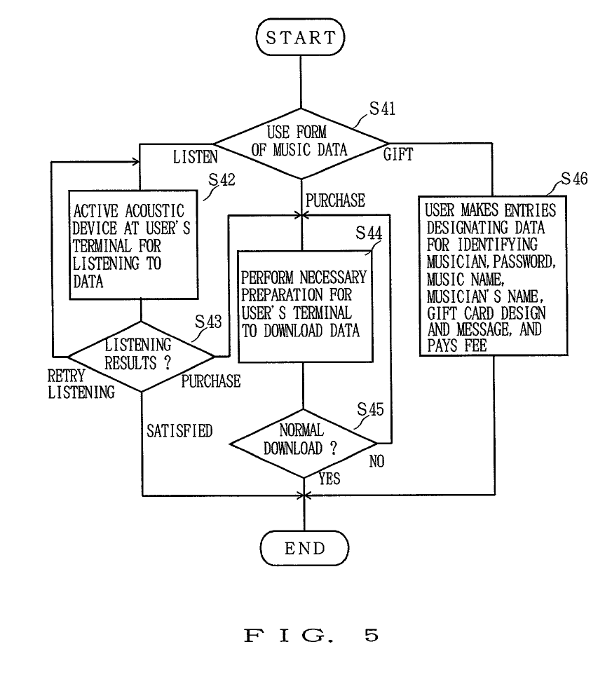

FIG. 5 is a flowchart showing the individual operations performed in accordance with the selected form for using the music data. When <listen> is selected at step S41, the acoustic device attached to the user terminal is activated for listening (step 42). After the user has listened to the music data, the listening results are determined (step S43). When only listening has been desired and the user is satisfied, the process is terminated. When the listening was unsatisfactory, the user clicks on <re-listen> and repeats the process beginning with step S42. For re-listening, the user is permitted one or several trials; however, depending on the case, the re-listening can also be inhibited. When the user desires to purchase the music data as a result of listening to it, at step S41 the same process is performed as when <purchase> is selected.

When <purchase> is selected at step S41, a predetermined process is performed by the user terminal to download the music data to a removable storage medium, such as a CD-R/RW or a DVD-R/RW, or to a hard disk (step S44). Then, a check is performed to determine whether the music data has been normally downloaded (step S45). When normal downloading has been performed, the processing is terminated. When the music data has not been normally downloaded, the process beginning at step S44 is repeated.

When <gift> is selected at step S41, the template or the input format provided by the system Sy is employed to at least partially enter data for a language, the type of gift, the names of a country and an area, the name of a sender, data for designating a gift recipient, a password, an address, the registration number for a magazine, a music name, a musician name, and to obtain samples for a title, a message and the design of a card to be attached to the gift. The payment of a predetermined fee is also obtained (step S46).

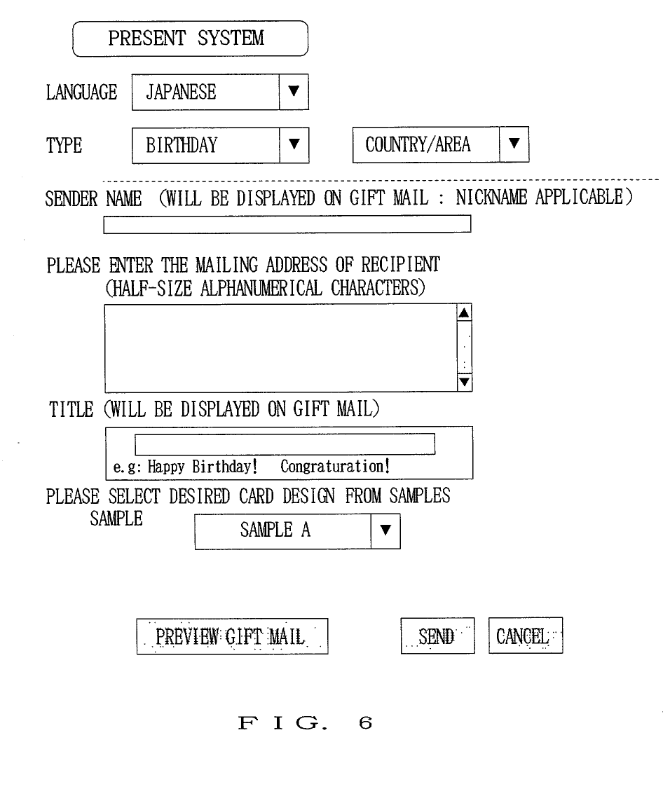

FIG. 6 is a diagram showing an example screen displaying a template used to designate a music data gift for the music data mail magazine issuing system according to the invention.

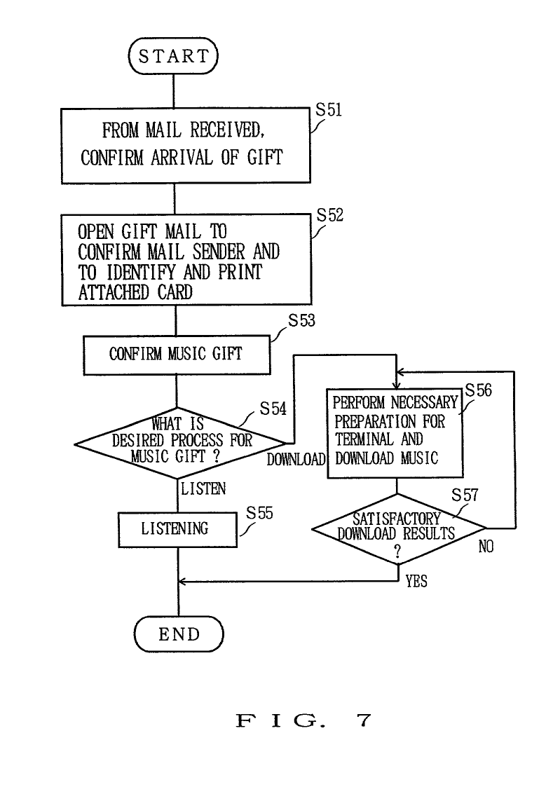

An overview of the operation and processing performed by the gift recipient will now be described while referring to FIG. 7. Received mail is examined and the arrival by mail of a gift is confirmed (step S51). Then, the mail is opened, the name of the sender is identified, and the name and an attached card printed on the screen (step S52). Next, the music data constituting the gift is identified (step S53), and a desired process for handling the gift is selected (step S54). When <listen> is selected, only one hearing trial is given (step S55). When <download> is selected, a predetermined process is performed to download the music data (step S56). Following this, the downloading results are examined, and if the results are satisfactory, the processing is terminated. When the downloading failed or when the medium is incomplete, the downloading is again performed at step S56 and the following steps. In this case, the times the downloading can be repeated can be limited to a predetermined number.

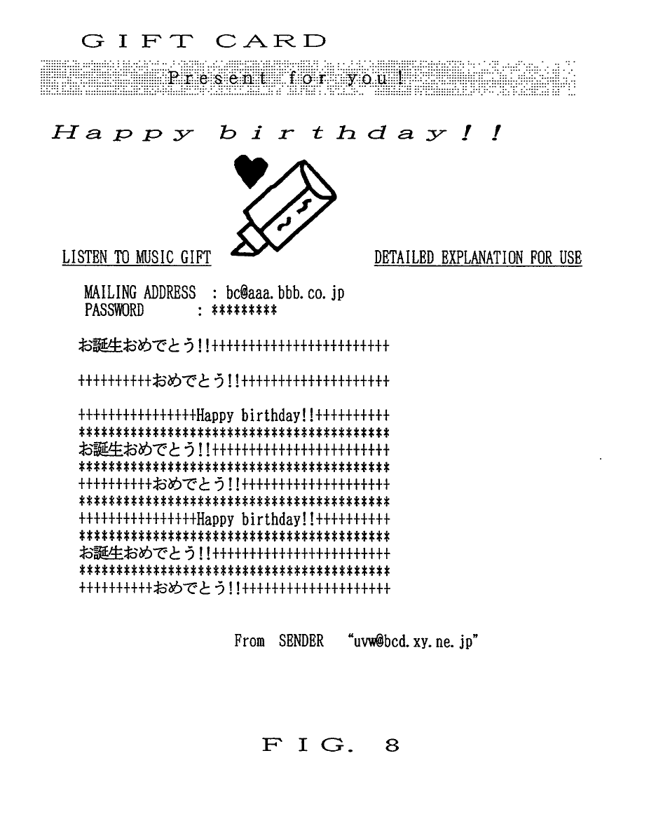

FIG. 8 is a diagram showing an example greeting card when the gift is for a birthday. The greeting card may be provided by arbitrarily selecting and combining designs and elements that are prepared not only for a marriage, a wedding anniversary, school matriculation or graduation and employment, but also an inquiry concerning health and consolation for a broken heart or a tragic accident. The greeting card may also be constituted as a completely original design or message. The design, the arrangement and the character strings shown are merely examples; no limitation is placed on those that can be used.

As is described above, according to the music data distribution, mail magazine issuing system of the invention, a mail magazine composed mainly of music data, such as the playing of original music, an ensemble and an ensemble with a song, can be freely issued in accordance with a determination made by the system, regardless of the time and the place. Therefore, the distribution and the dispersal of original music data, regardless of whether it is by a professional, a semi-professional or an amateur, can be performed.

Since this system is employed, an opportunity to disclose a work can easily be obtained without worrying about any barriers, such as whether a big sale can be expected, that may be encountered with a conventional music data distribution company, such as a recording company, a broadcasting station or a music agent's office. Therefore, it is easy for a new star to take a chance on self-promotion without running any big risk, and for a comparatively popular artist to easily obtain an opportunity to disclose a work that reflects his or her own tastes.

Furthermore, since registration for this system is free, or only an extremely low fee is charged, and since no registerers are discriminated against, anybody, including persons under twenty, students, housewives and elderly people, can easily transmit and personally distribute original music data worldwide, via the Internet, so that new stars can be created outside the conventional music industry. In addition, the mail magazine is itself an effective advertisement medium, and the user registration data it contains are valuable to fans of individual artists and genres, and extremely effective as a listing for the transmission of advertisements for subsequent works or for associated sponsors.

Music data can be a unique gift for a family member, a friend, a lover, a classmate or a colleague, and can be easily and quickly transmitted worldwide, without any geographical restrictions, as a long-lasting gift that can be enjoyed simply by listening or by downloading and printing it on a card.

Various modes of carrying out the invention are contemplated as being within the scope of the following claims that in particular point out and directly claim the subject matter that is regarded as the invention.

What is claimed is:

1. A music data distribution, mail magazine issuing system, that permits users to access and to display, listen to and/or download registered data designated by said users, comprising:
a music data server, for uploading and registering music data held by registration applicants and for distributing said music data on line upon receiving requests from users;
a mail magazine server, for registering correlated character data and/or image data associated with said registration applicants, and/or music data and for, as needed, distributing on line said character data and/or said image data together with information provided from said music data distribution, mail magazine issuing system;
a total management server, for managing and controlling the entire system, that includes a function for examining the copyrights of data registered at said servers or, when problems arise related to public order and morals and other associated problems, for determining legal registration appropriateness and for selecting and registering only legally appropriate data.

2. A music data distribution, mail magazine issuing system according to claim 1, wherein an information distribution form used by said mail magazine server is a mail magazine issued for said registration applicants, and said data is character data, including songs associated with data registered in said music data server, registerer profiles, self-advertisements, registerer messages to music data users, and live concert information.

3. A music data distribution, mail magazine issuing system according to claim 1 or 2, further comprising:
a function, based on said registration data for said music data user, for automatically transmitting information for a succeeding issue date and the opening date for a live concert.

4. A music data distribution, mail magazine issuing system according to one of claims 1 to 3, further comprising:
a music data gift function for receiving the name of a musical piece selected by a user who is a member of said system, an instruction for predetermined entries and a fee paid by said user, and for permitting a third party designated by said user to listen to and/or download music data.

5. A music data distribution, mail magazine issuing system according to one of claims 1 to 4, further comprising:
a music data gift function for enabling the on-line transmission, to a third party designated by said user, of associated character data and/or image data that accompany said music data.
